(19) United States
(12) Patent Application Publication
(10) Pub. No.: US 2008/0223376 A1
(43) Pub. Date: Sep. 18, 2008

(54) Adjustable Heimlich maneuver device

(76) Inventors: Robert K. Delaplane, Camden, IN (US); John S. Giddens, St. Louis, MO (US)

Correspondence Address: Frank D. Lachenmaier;Suite 200, 116 N. Main St., P.O. Box 1047, Kokomo, IN, 46903-1047, US

(21) Appl. No.: 11/716,791

(22) Filed: Mar. 12, 2007

(51) Int. Cl. A61H 31/00

(52) U.S. Cl. 128/845

(57) ABSTRACT

This invention relates generally to a device to assist a smaller person in applying the Heimlich maneuver to a larger person that is sitting, standing or lying prone on his back or in performing the maneuver on himself.

### BACKGROUND

1. Field of Invention

This invention relates generally a device to assist a smaller person with applying the Heimlich maneuver to a larger person.

2. Prior Art

The Heimlich Maneuver is a well understood procedure for assisting a person that is choking on a piece of food lodged in his throat. It involves getting behind the choking victim, reaching around the victim with both hands, making a fist of one hand and placing it just below the rib cage of the victim, covering it with the second hand and performing a quick upward jerking motion, compressing the diaphragm and forcing air to flow rapidly through the esophagus dislodging the obstruction.

There are several problems with the standard approach to the Heimlich Maneuver. First if the victim is a much larger person than the care giver she might not be able to reach around him to get her hands in the proper position. In most food choking incidents the victim is sitting in a dining room chair which further complicates the reach around problem. Many other choking incidents occur when the victim is eating alone and there is no one around to institute the life saving technique.

There have been many attempts to resolve these problems as indicated in the cited patents and advertising literature. There are several that utilize a round ball shape as an approximation of the human fist. Some show use with one hand while others have either straight, rigid handles or flexible handles that serve to extend the caregiver's reach. Others have an active interface end mounted on some type of shaft that is be placed against some immovable object allowing the solitary victim to fall against the device, dislodging the obstruction.

None of the prior art devices however take the shape of the human breast plate and rib cage into consideration of the designs of their interface to the body. Many, even though they offer some reach extenders, do not provide sufficient reach for very large victims or small caregivers. The rounded or blunt interfaces do not allow for decreasing resistance to penetration that is achieved with sharper sloped interface surfaces.

### SUMMARY

The general object of the present invention is to provide an improved choking assist device.

The specific objectives of this invention are to provide a very low cost device for the assistance of choking victims by caregivers that:
1. are either too small or insufficiently trained in the Heimlich maneuver to effectively carry out the manual procedure.
2. can be utilized while choking victim is still seated.
3. can be utilized by a solitary victim on himself.
4. can be utilized while victim is lying on his back.
5. takes into account the shape of the sternum and rib cage for maximum pressure on the diaphragm while minimizing the potential damage to the ribs.

### DRAWINGS

In order that the invention may be more fully understood it will now be described by way of example, with reference to the accompanying drawings in which:

FIG. 1 is a front view of an Adjustable Heimlich Maneuver Device;

FIG. 2 is a rear view thereof showing the desk side support notch for self use;

FIG. 3 is a top view thereof;

FIG. 4 is a bottom view thereof;

FIG. 5 is a right side elevational view thereof, the left side elevational view being a mirror image;

FIG. 6 is a perspective view of an Adjustable Heimlich Maneuver Device;

FIG. 7 with victim sitting,

FIG. 8 with victim standing,

FIG. 9 with solitary victim and

FIG. 10 with victim lying on floor are perspective views of an Adjustable Heimlich Maneuver Device shown in positions of use wherein the broken line showings of the persons and the furniture are for illustrative purposes only and form no part of the claimed design.

### REFERENCE NUMERALS

The same reference numbers are used to refer to the same or similar parts in the various views.

12 - Adjustable Heimlich Maneuver
Device
14 - body
16 - strap
18 - front surface
20 - back surface
22 - desk side support notch
24 - front directional indicator
26 - back directional indicator
28 - hand rest

### DESCRIPTION

In order that the invention may be more fully understood, Adjustable Heimlich Maneuver Device 12 will now be described by way of example with reference to the accompanying drawings.

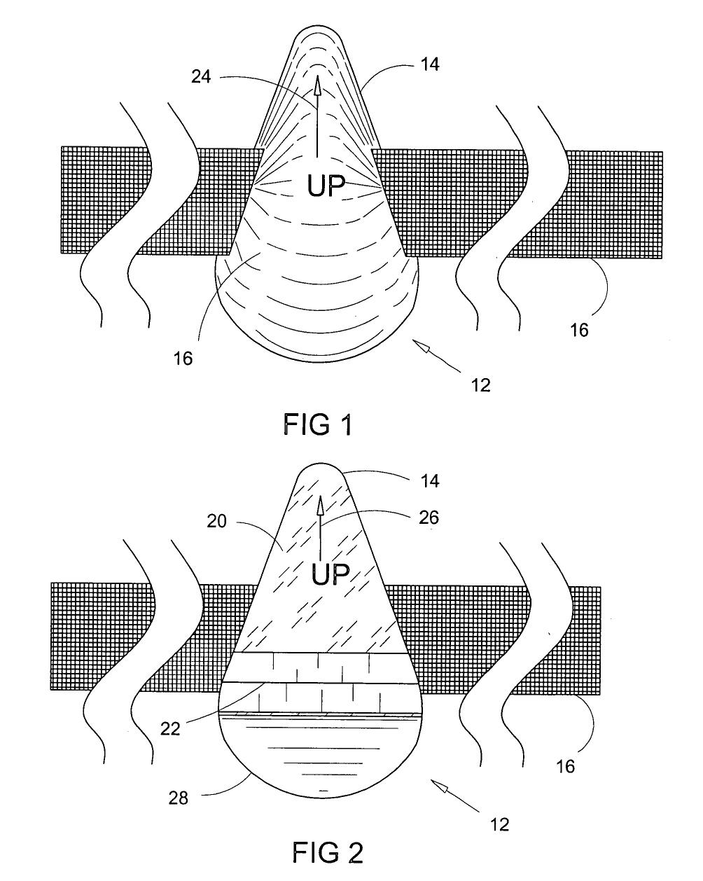

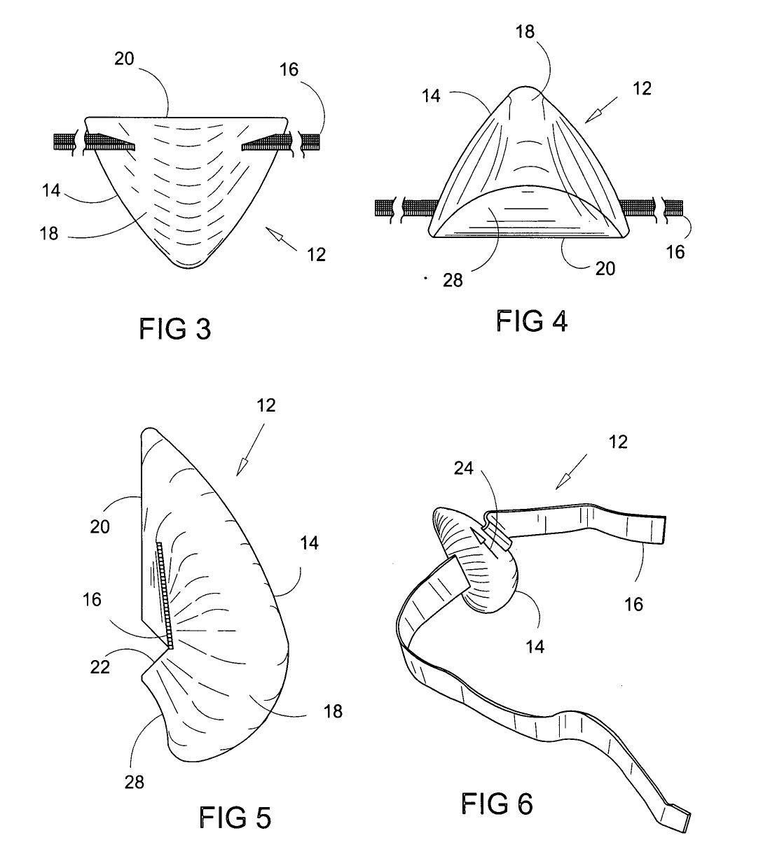

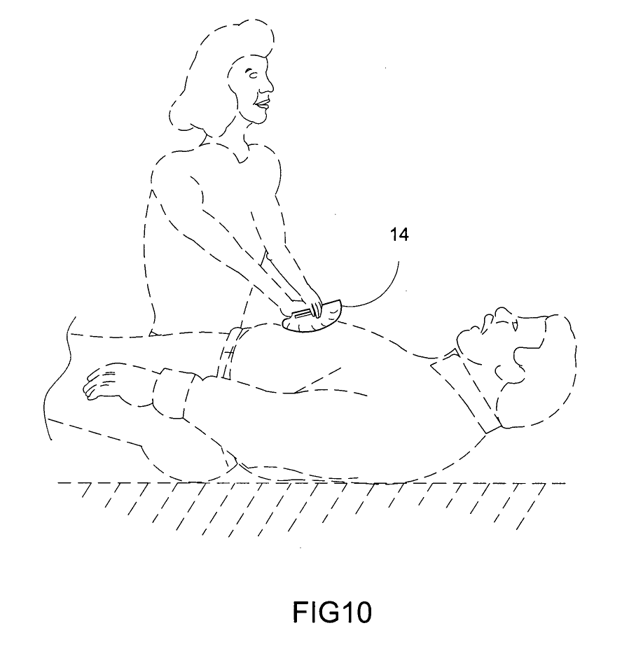

FIGS. 1-6 illustrate Adjustable Heimlich Maneuver Device 12. It is comprised of body 14 and strap 16. Body 14 has front surface 18 that has a concave shape, narrower at the front and top and wider at the back and bottom as illustrated in FIGS. 1-5. Body 14's back surface 20 has desk side support notch 22 embedded at approximately a 45 degree angle as shown in FIGS. 2-5. It also has hand rest 28 across the bottom of back surface 20 for manually applying force to body 14 when victim is in prone position as in FIG. 10. Strap 16 is a flexible strap that is either connected on each side of body 14 or body 14 has a slip fit slot through body 14 on which body 14 slides on strap 16 as shown in FIG. 6 and is of sufficient length to allow even a small caregiver to reach around a very large adult.

### Operation:

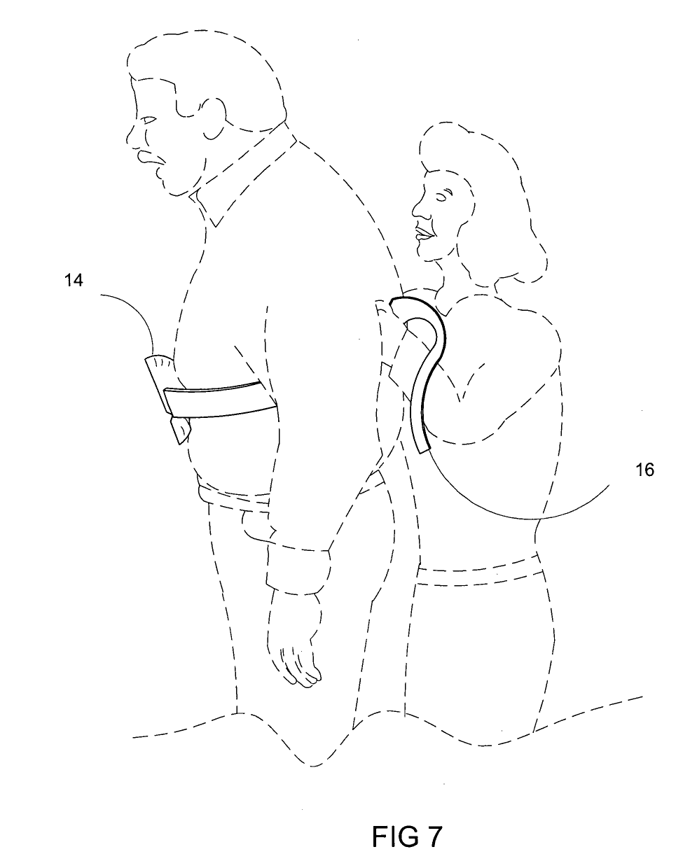

FIG. 7 illustrates a standard use of Adjustable Heimlich Maneuver Device 12 as body 14 is shown placed between the navel and sternum and strap 16 is wrapped around the hands of a caregiver and utilized to pull body 14 rapidly upward in a jerking motion to expel a large burst of air by applying force to the stomach, diaphragm and lungs. The shape of body 14's front surface 18 is critical to the improved function relative to standard spherical shapes and is designed to fit between the navel and the sternum. The narrowing at the interface front edge allows for the force to be concentrated in a smaller area increasing the local pressure at point of attack. The top to bottom taper allows body 14 to be nestled close to the sternum directly over the diaphragm without putting pressure on the victim's ribs which suffer the most damage from improperly applied Heimlich Maneuvers.

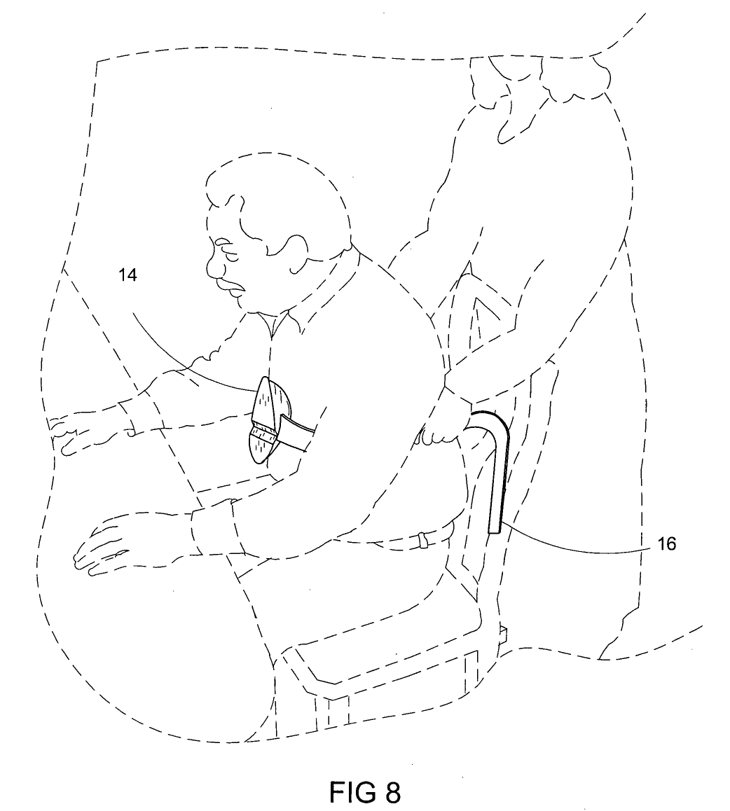

The fact that strap 16 is quite long allows a similar application even though the victim remains seated, perhaps even slumped over as shown in FIG. 8.

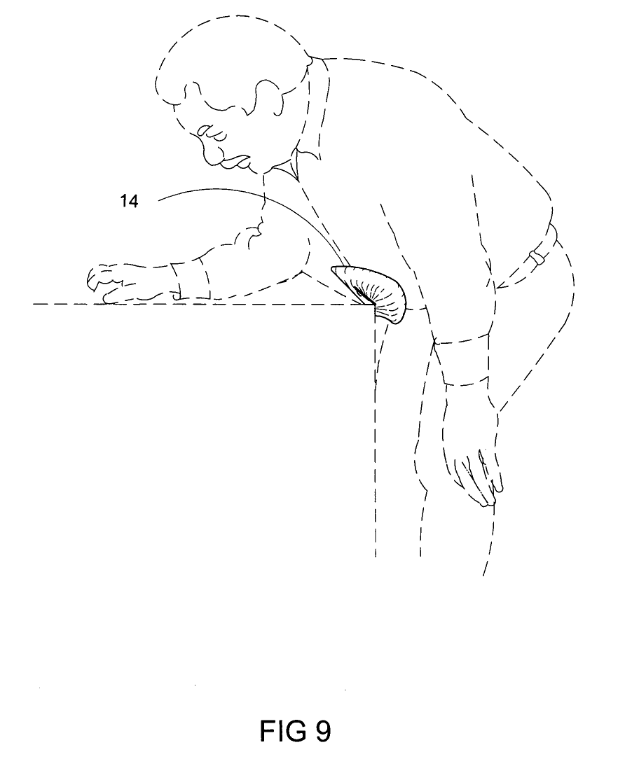

FIG. 9 shows an application of Adjustable Heimlich Maneuver Device by a solitary victim. In this case the victim places back surface 20 of body 14 at desk side support notch 22 on any square cornered solid piece of furniture, places his abdomen against front surface 18 of body 14 and leans sharply in a rearward and down motion forcing a burst of air, clearing the breathing channel.

FIG. 10 shows yet another method of use of Adjustable Heimlich Maneuver Device 12 where the victim has already fallen to the floor. In this case the victim is rolled onto his back and body 14 is placed in the same position as before and the heel of the care giver's hand is placed on hand rest 28 and a sharp downward and forward force is applied again forcing a burst of air through the larynx and clearing the air way.

What is claimed is:

1. An adjustable Heimlich maneuver device that when placed between the navel and the sternum of a choking victim and rapidly forced against the stomach, diaphragm and lungs causes air to rush out the throat of choking victim, freeing an obstruction, comprising a body with a front surface, a back surface, a top and a bottom where said front surface is concave with an apex, sides and a base that is narrower at said apex and top than it is at said base and bottom whereby said device's front surface fits below the sternum without contacting victim's ribs and said narrow apex allows for increased pressure at point of contact.

2. Adjustable Heimlich Maneuver Device as in claim 1 that further comprises directional indicators on said front and rear surfaces whereby proper placement of said device is self-explanatory.

3. Adjustable Heimlich Maneuver Device as in claim 1 further comprising a right angle notch embedded at a approximately a 45 degree angle in said back surface whereby self application is made possible by nesting said notch on a right angle top/side corner of nearest available desk or table, and making a sharp downward and rearward motion of the victim's torso against said device.

4. Adjustable Heimlich Maneuver Device as in claim 1 further comprising a hand rest toward said bottom, running across said back surface, whereby a caregiver's hand placed on said hand rest can apply a sharp downward and forward force on said device against a prone victim lying on his back.

5. An adjustable Heimlich maneuver device as in claim 1 further comprising either flexible straps that are attached to each of said front surface sides of said body or one continuous strap that said body slides on, whereby said straps are run under victim's arms, grasped by caregiver standing behind victim that is in either a sitting or standing position and are given a sharp upward and rearward tug.
